(19) United States
(12) Patent Application Publication
(10) Pub. No.: US 2003/0233154 A1
(43) Pub. Date: Dec. 18, 2003

(54) Method for presenting status to a host in a point-of-sale (POS) printer

(76) Inventor: Andrew Kobziar, Ithaca, NY (US)

Correspondence Address: HANCOCK & ESTABROOK, LLP, 1500 MONY Tower I, PO Box 4976, Syracuse, NY, 13221-4976, US

(21) Appl. No.: 10/174,873

(22) Filed: Jun. 18, 2002

(51) Int. Cl. G05B 11/01

(52) U.S. Cl. 700/13; 700/12; 700/23; 700/19; 700/11

(57) ABSTRACT

The present invention features a method for use by a printer connected to a host to guarantee that the host receives current status from the printer in response to any issued command, not merely a request for status command. The method ensures that the status received by the host corresponds to a command of interest to the host. In addition, when an error occurs in the printer, the host and its application program may determine exactly where in the sequence of transmitted commands the failure has occurred. This allows the host to intelligently restart the failed operation at an appropriate point in the command sequence. The inventive method has proven particularly useful in the point-of-sale (POS) environment.

### FIELD OF THE INVENTION

The invention pertains to printers and, more particularly, to a method for allowing a host computer to obtain accurate, timely and synchronized status from a point-of sale (POS) printer.

### BACKGROUND OF THE INVENTION

The environment in which printers currently must operate is typically characterized by asynchronous receipt by the printer of commands and print data from a host computer application. In the printer, this single stream of bytes is fed to both command interpretation and printing functions. All of the received data normally is first placed into an input buffer. The selected actions are performed at an unknown and varying time delays from the perspective of the host application.

Printers typically neither acknowledge receipt of a command nor inform the host of its successful (or unsuccessful) execution status. However, a few existing commands, such as status requests or requests to read MICR data, do have defined (i.e., application expected) return data from the printer. Generally, the application-to-printer Input/Output interaction may be modeled as two independent, single direction data “pipes.” From the printer's perspective, an input data pipe carries a stream of bytes fed into an input buffer. The buffered data is then interpreted and acted on in the order received, as quickly as the printer is able to perform the requested operation(s). An output data pipe returns any printer responses to the host and application. When the application has several responses pending from the printer, the sequence of returned data is, in some cases, insufficient to establish a one-to-one command-to-response linkage. This is because an error or other event could have occurred between the time the host issued a particular command and the time that the printer could respond.

In addition to the normal input data pipe from the host, sometimes another, special “real time” input data pipe is provided. Bytes (i.e., commands and data) sent down this special data pipe are acted on immediately as received rather than being placed in the input buffer to be acted upon in the order received. The instant invention does not pertain to commands issued by the host to the printer over this special input data pipe.

In POS printing, the host is entirely responsible for discovering and reacting to any printer errors. The host typically detects a printer error by issuing status commands to the printer. The POS class of printers, however, typically do not have common job control modes such as those widely used in page printers. These job control modes allow such activities as page level automatic recovery. Because POS receipt paper is supplied in a continuous roll, such page level reprints (i.e., automatic recovery) would be difficult and for the most part entirely impractical in a POS printer.

Presently, two classes of status commands are typically used in the POS printing environment: a solicited class and an unsolicited class. Solicited class status commands are issued by the host, and the printer responds by returning status information back to the host. Unsolicited class status commands are originated by the printer in response to a change of condition, and status is returned to the host asynchronously. In other words, these unsolicited status transmissions to the host are indeterminate (from the host's perspective) and are triggered by a change in the printer's status. In some cases, the host may optionally designate that only a subset of all of the possible printer state changes generate unsolicited status responses.

Some typical examples of the solicited status class are “Real Time Status Transmission”, “Transmit Peripheral Device Status”, and “Transmit Paper Sensor Status” as defined in the POS industry de-facto standard “ESC POS” collection of commands.

Examples of the unsolicited class are the “USTATUS” commands as defined in the de-facto general printer standard, PCL5 (originated by Hewlett Packard) and Axiohm Transaction Systems Corporation's Global and Automatic Printer Status commands. The present invention replaces and improves these USTATUS implementations by providing expanded functionality.

At least two problems for the host application program are caused by the present limited USTATUS implementation as included in the currently used printer command sets. These problems are both solved by the improved status reporting methods of the invention. First, the current USTATUS implementation cannot guarantee that the host will know absolutely whether a particular command has executed properly. Second, when an error is reported to the host by the printer, the host application often cannot tell where in the stream of commands, previously sent to the printer, the error occurred. The inventive method, on the other hand, provides a method for absolute reporting on the success or failure of a particular command issued by the host. Also, the inventive method can determine the point in the previously sent command sequence where a reported failure occurred. This allows intelligent, situation-specific printer restarts. The method of the invention provides the application with a positive indication that a command, especially one critical to the integrity of the printer output, has completed successfully.

Printer failures can be caused by many things. Typical examples of error causing events include: an operator opening the printer lid cover, a paper feed jam, and the printer running out of free memory space in the printer. Using existing commands, the application may periodically insert return status commands into the input stream to determine whether an error has occurred. However, this technique has proven to be insufficient as well as inefficient. Additional status information not presently provided by the printer is needed by the host. This additional data would be used by the application to determine which of the previously transmitted commands corresponds to a particular status report. This is necessary because multiple instances of the same command are often issued in close proximity to one another in the input data stream sequence. In addition, the printer's input buffer may hold a large number of commands. Because of this, there has heretofore existed no practical way for the application to positively associate commands with printer's responses.

### SUMMARY OF THE INVENTION

In accordance with the present invention there is provided a method for use by a printer connected to a host to guarantee that the host receives current status from the printer in response to any issued command, not merely a request for status command. In addition, when an error occurs in the printer caused, for example, by the operator inadvertently opening the printer cover, a paper jam, the printer running out of paper, etc., the host application program may determine exactly where in the sequence of transmitted commands the failure has occurred. This allows the host to intelligently restart the failed operation at an appropriate point in the command sequence. The inventive method has proven particularly useful in the point-of-sale (POS) environment.

It is, therefore, an object of the invention to provide a method wherein a host computer may be informed of the success or failure of the execution of any particular command sent by a host to a printer.

It is an additional object of the invention to provide a method for ensuring that status information sent to a host by a printer is matched to the proper command.

It is another object of the invention to ensure that the host can determine exactly where, in a sequence of commands sent by the host to a printer, a printer error has occurred.

It is a further object of the invention to provide a method whereby an intelligent restart of an incomplete printing operation may be provided by the host based upon accurate status reporting by the printer.

It is yet another object of the invention to provide a method whereby a printer may be instructed to return any printer state change in either a timed or unsolicited fashion along with information to allow the host to determine at which command the printer state change occurred.

### BRIEF DESCRIPTION OF THE DRAWINGS

A complete understanding of the present invention may be obtained by reference to the accompanying drawings, when considered in conjunction with the subsequent detailed description, in which:

FIG. 1a is a schematic block diagram showing a printer input buffer, pointers, and other associated values required for a printer command status (PCS) command;

FIG. 1b is a flow chart of the execution of a PCS command;

FIG. 2a is a schematic block diagram showing a printer input buffer, pointers, and other associated parameters required for a printer extended command status (PECS) command;

FIG. 2b is a flow chart of the execution of a PECS command;

FIG. 3a is a schematic block diagram showing a printer input buffer, pointers, and other associated parameters required for a POS USTATUS modes (PUSM) command;

FIG. 3b is a flow chart of the execution of a PUSM command;

FIG. 4a is a schematic block diagram showing a printer input buffer, pointers, and other associated parameters required for a POS USTATUS firmware implementation for implementing a PUSM command; and

FIG. 4b is a flow chart of the execution of a firmware implementing a PUSM command.

### DETAILED DESCRIPTION OF THE PREFERRED EMBODIMENT

The present invention provides a solution for overcoming the two deficiencies in the currently used, previously described status reporting methods in a POS-type printer. While printers operating in the POS environment can benefit greatly from the methods of the present invention, they are by no means considered limited to use in that environment.

The method of the present invention provides three new commands: printer command status (PCS), printer extended command status (PECS) and POS USTATUS modes (PUSM) command.

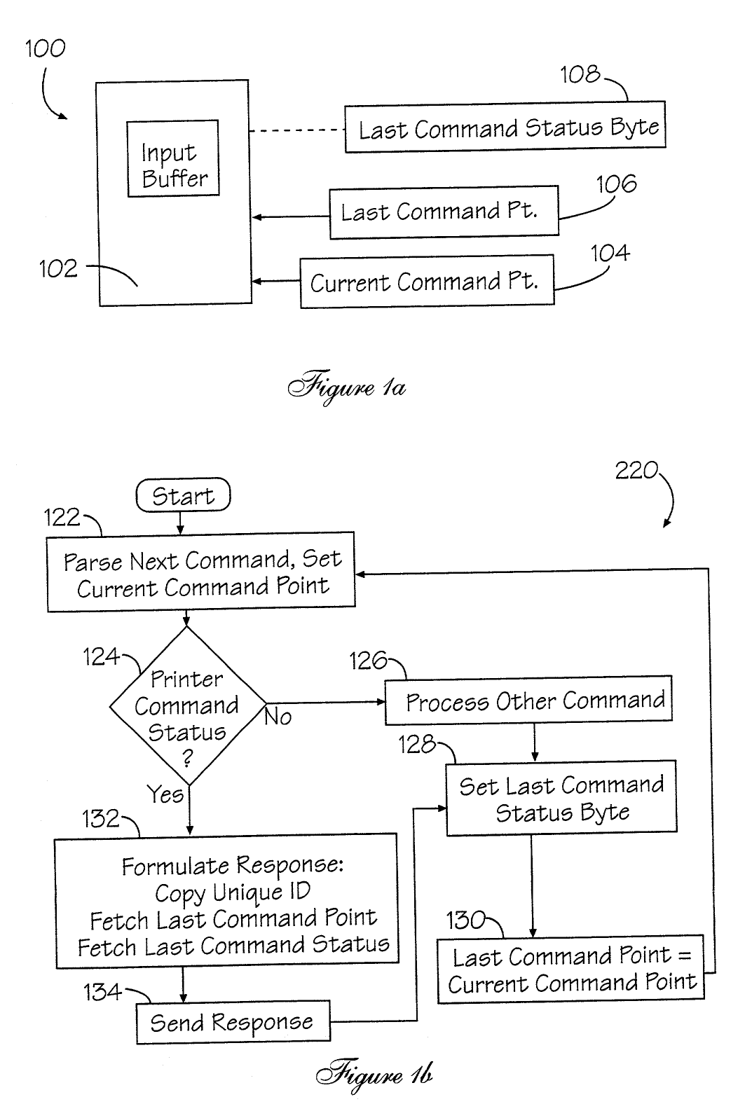

Referring first to FIG. 1a, there is shown a generalized schematic block diagram 100 of an input buffer sub-system of a typical printer (not shown). An input buffer 102 is formed from read-write memory and is sized to accommodate the anticipated quantity of data and commands necessary in a particular printer environment. Printer input buffers 102 are well known to those skilled in the art and the details of its implementation forms no part of the instant invention.

Two pointers 104, 106 point to two different regions of input buffer 102. The content of input buffer 102 is assumed to be a stream of data bytes comprising both characters to be printed and commands sent from a host computer. Pointer 104 is the Current Command Pointer and pointer 106 is the Previous Command Pointer. Also shown schematically is a region of memory 108 or, in alternate embodiments, a register (not shown) for storing a status byte associated with the last executed command. While a single byte has been chosen for purposes of disclosure, it should be obvious that multiple bytes of status information could be used to meet a particular operating circumstance or environment.

Referring now also to FIG. 1b, there is shown a flow chart 120 of the steps for processing the inventive printer command status (PCS) command. A command recognition and interpretation circuit and/or software routine within a printer (not shown) is adapted to identify commands within the stream of data (not shown) residing in input buffer 102. The data stream is scanned and each command located. Each command is parsed, step 122, and the current command pointer 104 is loaded with the memory location (i.e., address) in the data stream within input buffer 102 where the command resides.

If the command is not a PCS command, step 124, the command is processed (i.e., executed) normally, step 126. Upon completion of the command execution, step 126, a last command status byte 108 is set, step 128. The last command pointer 106 is then loaded with the information currently in the current command pointer, step 130. Processing resumes at step 122 and the next command in the data stream is processed. If, however, the command currently being processed is a PCS command, step 124, a response to the host is immediately formulated, step 132.

A PCS command sent by the host consists of two parts: the first part is the op code identifying the command as a PCS command; the second portion of the command is a quasi-unique ID associated with only this instance of the PCS command. This quasi-unique ID allows the host to match responses from the printer with particular instances of the previously issued commands. The response to the host from the printer contains the quasi-unique ID received in the PCS command as well as the contents of the last command pointer and the last command status byte(s). This response is immediately sent to the host, step 134. The last command status byte is then set, step 128, the contents of the current command pointer transferred to the last command pointer, step 130, and control returned to step 122 so that additional commands may be parsed and executed. This process continues for as long as the host continues to send data to the printer.

By including the quasi-unique ID in the command sent to the printer, the host may readily pair the responses received from the printer with a particular command (i.e, the one with the quasi-unique ID).

The quasi-unique ID used for purposes of disclosure is an integral number which is incremented by the host each time a command is issued. It should be obvious that many different methods of formulating a quasi-unique ID are well known to those skilled in the art. Any of these methods could be used to generate a suitable quasi-unique ID. The actual method for generating a quasi-unique ID forms no part of the instant invention.

The PCS command, when used in conjunction with suitable software routines at the host, allows the host to request status for a particular command and to know unequivocally whether that command was successfully executed. The requirement for matching the quasi-unique IDs accomplishes this.

The second problem discussed hereinabove is creating a linkage between a command being executed by the printer at the time that a notable event occurs and the consequent status response from the printer. Such a linkage allows the host to know how many of a stream of commands were properly executed before the notable event occurred. The method of the present invention solves this problem with the introduction of the two additional commands: the printer extend command status (PECS) and the POS USTATUS mode (PUSM) commands. The PUSM command provides additional functionality to the well known and commonly used unsolicited status (USTATUS) commands of the prior art.

Timely alerting the host concerning a printer problem, as currently done using a conventional USTATUS command, is necessary but not sufficient, especially in the POS environment. The host also requires data to correlate the error or other notable event to the point in the command stream where the failure occurred. The solution to this problem is provided by the new PECS and PUSM commands.

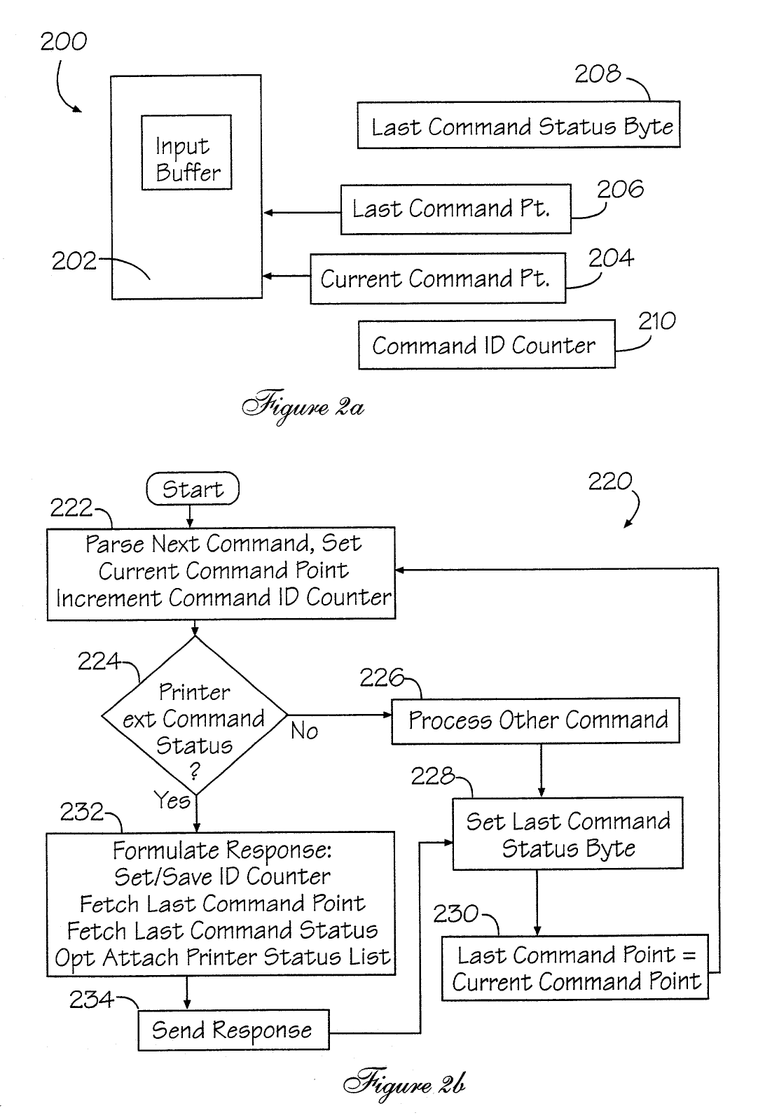

Referring next to FIG. 2a, there is shown a generalized schematic block diagram 200 of another input buffer sub-system of a typical printer. An input buffer 202 is formed from read-write memory and is sized to accommodate the anticipated quantity of data and commands necessary in a particular printer environment. Two pointers 204, 206 point to two different regions of input buffer 202. Pointer 204, like pointer 104 (FIG. 1a), is the Current Command Pointer and pointer 206 is the Previous Command Pointer. Also shown schematically is a region of memory 208 or a register (not shown) storing a status byte associated with the last executed command. In addition, a command ID counter 210 is provided.

Referring now also to FIG. 2b, there is shown a flow chart 220 of the steps for executing a PECS command in a printer. The PECS command also uses a quasi-unique ID identifier. However, as used with the PECS command, both the printer and the application construct equivalent (i.e., identical) quasi-unique IDs. In the embodiment chosen for purposes of disclosure, the quasi-unique identifier is given a common start value of both the printer and application program. As each command is issued by the host, its quasi-unique ID value is incremented. Likewise, as the printer completes executing a command, the printer's quasi-unique ID value is also incremented. The host/application keeps a local history, mapping host-generated quasi-unique IDs with individual issued commands. When status is returned by the printer to the host for a command, either failed or successfully completed, the application can match the quasi-unique ID with its own (i.e., in local history) to easily identify the command for which the printer is returning status. The preferred embodiment for such quasi-unique identifiers are integers that are incremented for each command sent into the standard input stream pipe or executed at the printer.

A Printer Extended Command Status (PECS) command consists of three parts: the op code that identifies this particular printer command, the quasi-unique integer supplied by the application, and a flag that tells the printer whether to return all of its current status values. Returning all of the printer's current status gives the application a comparative baseline. If the unique integer supplied is 0, then the printer returns the lower order two bytes of its input buffer command counter. If the application passes a value other than zero to the printer, then this passed value is used to set the two low order bytes of the printer's command counter, possibly re-synching to the application's value for the immediately preceding command. The PECS command returns the command counter, the preceding command control (op) code and its state of execution, as well as, optionally, enumeration of the complete current status of the printer.

In addition to the new PECS command, existing general printer unsolicited status (USTATUS) functionality is extended to simultaneously notify the host of any printer state changes and convey the necessary linkage data. This allows the host to determine at what command the failure occurred. To make use of this linkage data, the application should have issued a PECS command and started (or continued) counting each command placed in the normal input pipe.

The third new command of the present invention is the POS USTATUS modes (PUSM) command. This command has three parts: the control (op) code that identifies this particular command, a first flag that enables or disables the sending of specified recurring timed or unsolicited status reports back to the host, and a second flag that indicates whether to enable unsolicited status reporting for the non-timed case of a printer power failure. Alternately, the last command status may be attached to all returns. In addition, the number of seconds for the timed recurrence in the timed case may be returned.

Once a mode is set, the printer sends unsolicited or timed status returns. These consist of a state change flag value, which could be 0 in the timed case when no changes occurred in the preceding interval, an ID, and the last command plus the last command status if the notable event was not a power failure event.

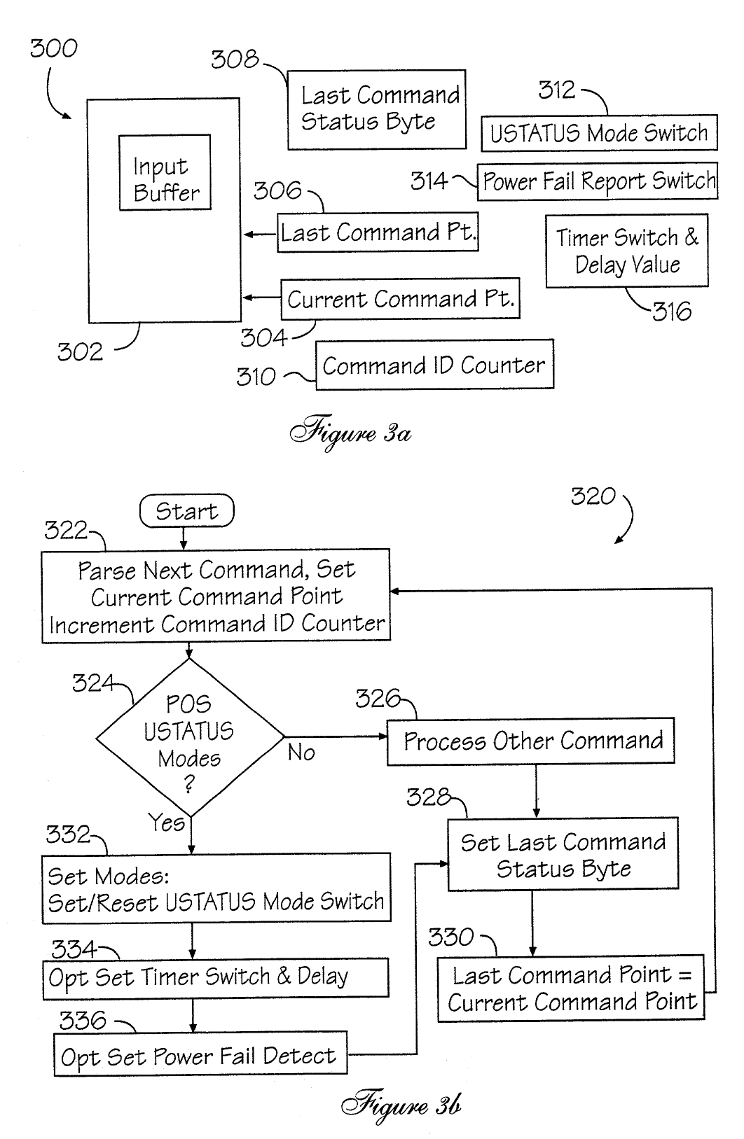

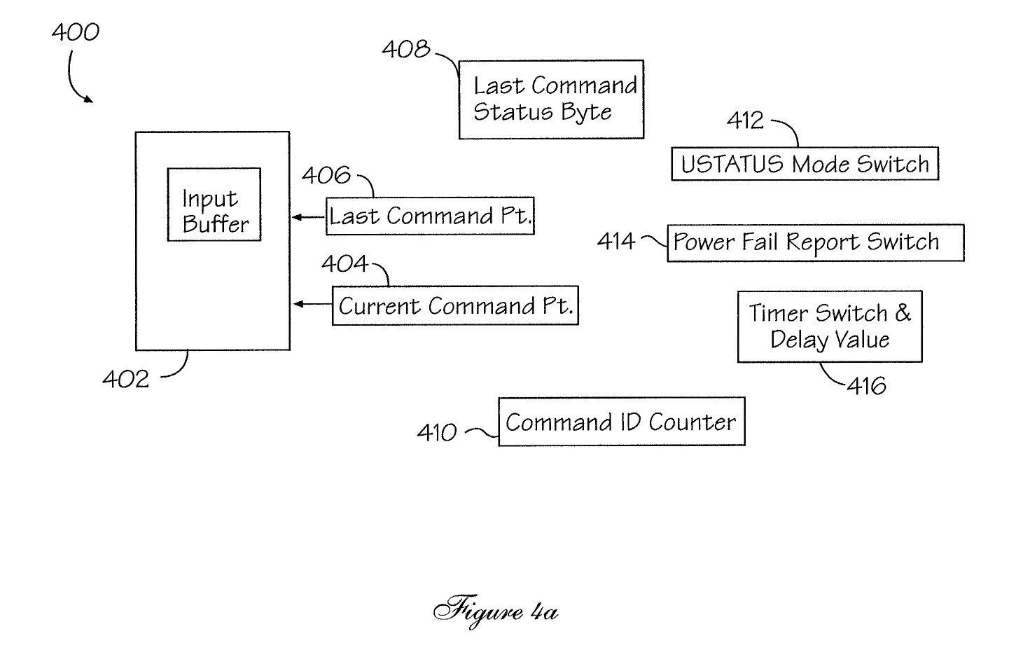

Referring now to FIG. 3a, there is shown a schematic block diagram 300 of yet another in put buffer sub-system of a POS printer. An input buffer 302 is formed from read-write memory and is sized to accommodate the anticipated quantity of data and commands in a particular printer environment. Two pointers 304, 306 point to two different regions of input buffer 302. Pointer 304, like pointer 104 (FIG. 1a), is the Current Command Pointer and pointer 306 is the Previous Command Pointer. Also shown schematically is a region of memory 308 or a register (not shown) storing a status byte associated with the last executed command. In addition, a command ID counter 310, a POS USTATUS mode switch 312, a power failure report switch 314, and a timer switch and delay value memory regions are shown.

Referring now also to FIG. 3b, there is shown a flow chart 320 of the steps for executing a PUSM command. First, the current command in input buffer 302 is parsed, the current command pointer is set and the command ID counter is incremented, step 322. If the current command is not a PUSM command, step 324, the command is processed normally, step 326, the last command status byte is set, step 328, the current command pointer is moved to the previous command pointer and control is returned to step 322. If, however, the current command is a PUSM command, step 324, the USTATUS mode switch is set or reset, step 332. The set time switch and delay values are set, step 334, and the set power failure detect switch is set, step 336. The last command status byte is then set, step 328. Finally, the current command pointer is moved to the previous command pointer and control is returned to step 322.

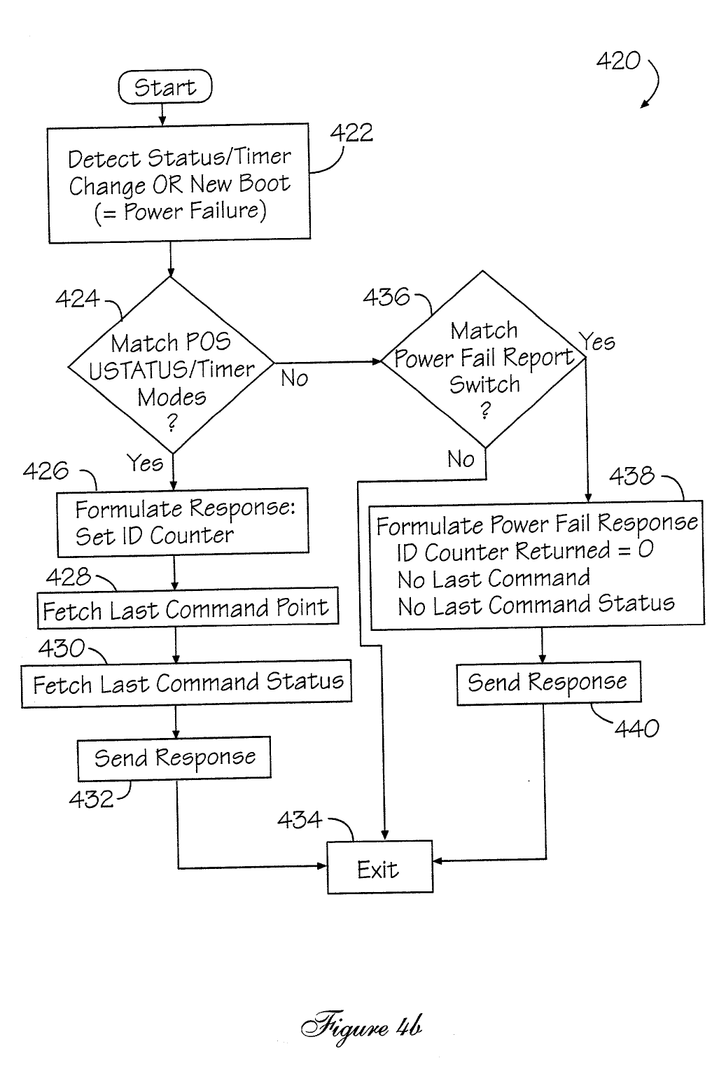

Referring now to FIG. 4a, there is shown a schematic block diagram 400 of an input buffer sub-system of a typical printer. The input buffer sub-system 400 is substantially the same as input buffer sub-system 300 (FIG. 3a). Two pointers 404, 406 point to two different regions of input buffer 402. Pointer 404, like pointer 104 (FIG. 1a), is the Current Command Pointer and pointer 406 is the Previous Command Pointer. Also shown schematically is a region of memory 408 or a register storing a status byte associated with the last executed command. In addition, a command ID counter 410, a USTATUS mode switch 412, a power failure report switch 414 and a timer switch and delay value memory regions are shown.

Referring now also to FIG. 4b, there is shown a flow chart 420 of the steps of one possible firmware routine for implementing the PUSM command of the invention. Circuitry is provided within the printer (not shown) to detect any change in status within the printer, monitor one or more timers, and to specifically detect whether the printer has lost power, step 422. If the current status condition matches the POS USTATUS or the timer modes, step 424, a response to the host is immediately formulated. The ID counter is first set, step 426. The last command pointer is fetched, step 428, and the last command status is fetched, step 430. All of this information is immediately sent to the host, step 432, and the firmware routine exits, step 434.

If, however, the current status does not match the POS USTATUS or the timer modes, step 424, the status is checked to determine whether it matches the power failure report switch value, step 436. If there is a match, step 436, a power failure response is formulated. First, the ID counter is reset to 0, step 438. Neither a previous command pointer nor last command status is available, so none is included in the response being formulated. The power failure response is then sent to the host, step 440, and the firmware routine exits, step 434.

In the embodiment chosen for purposes of disclosure, each of the commands of the invention has been given specific implementations. It should be obvious that many different choices of op codes, return codes and parameters could be chosen to accomplish the same or similar functions.

Printer Command Status (PCS) Command:

Command format (hex): 1D 94 nL nH

Purpose: The Printer Command Status (PCS) command returns the status of the input stream's immediately preceding command. In instances where commands are automatically inserted by the operational effect of the preceding command, such as in executing a macro, the status returned is that of the most immediate command before the PCS command is handled by the printer. In this case, the last input stream command is the last recognized command inside the macro. Consequently, status is returned, consistent with the treatment of the macro as a temporary diversion of the input stream away from the communication port. All immediate commands are handled outside the normal input stream; thus, their status is not reported by execution of a PCS command.

Arguments: nL+nH*256 is an application supplied integer ID (i.e., the quasi-unique ID code), which can be used to distinguish this particular status response from other similar responses from commands that were ahead of this command in the input stream buffer. This value should be greater than 0 and, when RS232 XON-XOFF protocol is being used, neither byte should be an 11H or 13H in order to avoid confusion in interpreting returned data.

The PCS command can be interactively used by the application to verify that a previous critical command executed successfully rather than being ignored or not carried out due to an abnormal printer condition. It is executed in input stream processing sequence, as contrasted with real time status commands, and its response is distinguished by an 0×1DH first byte and an 0×94H second byte. This status command is a complement to the existing Transmit Status Command (1D 72 nH), which returns the values of selected printer states, such as whether adequate receipt paper is present, etc.

The return bytes are defined as follows:

1 D 94 nL nH c1 c2 f

where: (nL nH) is the application's supplied quasi-unique unique ID number;

c1-c2 are the command bytes of the immediately preceding command (c2 may be 0 for short commands); and

(f)=0 if there were no errors.

The values of byte (f) are defined as follows:

| F | meaning |
|---|---|
| 0 | good command |
| 1 | resource limit, command failed |
| 2 | ignored command, skipped |
| 3 | other command failure |
| 8 - only when RS232 | good command, but c1/c2 were really |
| XON/XOFF protocol on | 11/13 but sent back as FB/FD |
| 9 - only when RS232 | resource limit, but c1/c2 were really |
| XON/XOFF protocol on | 11/13 but sent back as FB/FD |
| 10 - only when RS232 | ignored command, but c1/c2 were really |
| XON/XOFF protocol on | 11/13 but sent back as FB/FD |
| 11 - only when RS232 | failed command, but c1/c2 were really |
| XON/XOFF protocol on | 11/13 but sent back as FB/FD |

If the communications protocol is RS232- Xon/Xoff, then “X” symbol substitution response should be configured with the Setting Communications Parameters command (US STX, IF 02).

Printer Extended Command Status (PECS) Command

Command Format: 1D 95 nL nH s

Purpose: The Printer Extended Command Status (PECS) command is an extension of the PCS command. The PECS command returns the status of the last command executed in the input stream and, optionally, all of the state values of the printer. In instances where commands are automatically inserted by the operational effect of the preceding command, such as in executing a macro, the status returned is that associated with the most immediate command in the input stream before the PECS command is handled by the printer. In this case, the last input stream command is the last recognized command inside the macro, so its status is returned, consistent with the treatment of the macro as a temporary diversion of the input stream away from the communication port. All immediate commands are handled outside the input stream and thus are not reported on by this command.

In cases of RS232 connected devices with XON/XOFF protocol selected, it is recommended that “X symbol substitution responses” also be selected when configuring the printer's serial port. This requires that the application, upon receiving a byte having the value FE, discard that byte and use the next byte to recover the true value, either FE or 11 or 13.

Arguments: nL+nH*256 is an application supplied integer ID (i.e., the quasi-unique ID value), which can be used to distinguish this particular status response from other similar responses from commands that were ahead of this command in the input stream buffer. If the supplied integer is equal to 0, then the printer returns the two least significant bytes of its input stream command counter (i.e., the value associated with this command). If the supplied integer is not 0, then the passed value is used to reset the low order bytes in the command counter. Additional information about the command counter is provided hereinbelow.

The “s” parameter is a flag. If s=0, then do not return extended printer state; if s>0, then return the entire printer state list for this particular printer configuration. The possible values are shown hereinbelow. The PECS command issued with s=0 can be interactively used by the application to verify that a previous critical command executed successfully, rather than being ignored or not carried out due to some printer problem. The PECS command is executed in normal input stream processing sequence, as contrasted with the real time status commands, and its response is distinguished by an 0×1DH first byte and an 0×94H second byte. The PECS command is a complement to the existing Transmit Status Command (1D 72 nH), which returns the values of selected printer states, such as whether adequate receipt paper exists, etc. Also, the PECS command may be issued immediately after sending POS USTATUS modes commands. This give the application a command count starting value which is then used in the application's parallel command counting to establish restart points. These values are needed for handling future unsolicited status returned data. The returned ID number represents an ongoing count of all recognized input stream commands. When optionally included with unsolicited status responses, the PECS command may be used to indicate the point at which printing stopped. This count value feature makes possible a synchronization around the standard host/printer asynchronous input/output communications stream.

The return bytes are defined as follows:

1D 94 nL nH c1 c2 f [m [s₁ . . . sₘ]]

where: (nL nH) is the application's or printer command counter's supplied quasi-unique ID number;

c1-c2 are the command bytes of the immediately preceding command (c2 may be 0 for short commands) and (f)=0 or 4 if there were no errors.

The values of byte (f) are defined as follows:

| | m - count of | |
|---|---|---|
| F | bytes to follow | [s₁ − sₘ] |
| 0 - good command | not returned | None |
| 4 - good with | M | m printer state bytes, a list |
| printer state | | of values from the |
| | | enumeration table |
| 1 - resource limit | M = 2 | pL pH - number of input |
| | | stream bytes discarded |
| 2 - ignored command | M = 3 | pL pH n - bytes discarded |
| | | and n = first parameter not |
| | | acceptable |
| 5 - resource limit + | m > 2 | pL pH [s₃ − sₘ] - count of |
| printer state | | bytes discarded followed |
| | | by printer state |
| | | enumeration list |
| 6 - ignored | m > 3 | pL pH n [s₄ − sₘ] - discard |
| command + printer | | count, 1 parm error, |
| state | | followed by printer state |
| | | enumeration |
| f > 6 | M = 0 | A command error |
| | | occurred, but is not |
| | | describable by further |
| | | returned bytes |

Extended Return Definitions:

Value m is a count of the rest of the bytes returned and is present in the return string whenever f>0.

In most returns where the pervious command failed, an integer count pL pH of all the bytes which were discarded from the input stream (the command and parameter byte(s)) is also returned. This count includes the command bytes. A value of f>6 is used to indicate that this data is not applicable or is unavailable.

If the reason that a command was not processed is because it was ignored, such as a parameter problem, not being enabled due to printer configuration, or for some other reason, then n is the offset from the beginning of the command where the ignore decision was made. In a hypothetical situation, if the single byte command 0×02H was ignored by the printer, then n=0 (1st byte=no address offset) is returned. If n=0×FFH, then the offending parameter is located at address offset >=255. This implies that the error is of a class that includes failures such as a timeout occurring before receiving an expected null termination byte.

The value f=4 indicates a good previous command with a return of the (configuration dependent) list of printer stats, as given in the enumeration value table that follows.

The value f=6 is used to denote a previous command error that is not further described in the returned data.

| Enumeration state | |
|---|---|
| values | Meaning |
| 0 | No change in status since last |
| | response |
| | Printer power cycle occurred |
| 21 | Paper low |
| 22 | Paper out |
| 23 | Paper state OK |
| 24 | Paper feed button pressed |
| 25 | Paper feed button up |
| 26 | Receipt cover up |
| 27 | Receipt cover closed |
| 28 | Cassette cover up |
| 29 | Cassette cover closed |
| 30 | Knife jam |
| 31 | Knife ready |
| 32 | Slip jammed |
| 33 | Slip not present |
| 34 | Slip leading edge sensor covered |
| 35 | Slip leading edge sensor |
| | uncovered |
| 36 | Slip trailing edge sensor covered |
| 37 | Slip trailing edge sensor |
| | uncovered |
| 38 | Cash drawer 1 open |
| 39 | Cash drawer 1 closed |
| 40 | Cash drawer 2 open |
| 41 | Cash drawer 2 closed |
| 42 | User data storage write failed |
| 43 | User data storage write address |
| | OK |
| 44 | Flash logo area inadequate |
| 45 | Flash logo area adequate |
| 46 | Thermal user character space |
| | inadequate |
| 47 | Thermal user character space |
| | adequate |
| 48 | Impact user character space |
| | inadequate |
| 49 | Impact user character space |
| | adequate |
| 50 | Thermal head temperature out of |
| | range |
| 51 | Thermal head temperature OK |
| 52 | Printer voltage out of range |
| 53 | Printer voltage OK |
| 54 | Printer input stream buffer near |
| | full |
| 55 | Printer input stream buffer OK |

For example, the full report of states for a hybrid printer (with knife and MICR features) and with no problems encountered would have a response in which the last 20 bytes start with pL pH=0 0 (no bytes discarded) as follows:

1D95nLnHc1c2 0200002325272931333537394143454749515355

POS USTATUS Modes Command

Command Format: 1D 96 m n H Purpose: This command enables or disables the unsolicited sending of printer state values back to the host whenever there is a change in any of the printer's configured states. An option is provided to return printer state on a timed basis (i.e. a pseudo state change=timer running out). The modes settings can enable unsolicited responses which return a state change notification that can optionally have appended a command count and status of the last command executed. A persistent version of this command is also available which sets up the unsolicited modes to be retained by the printer across power loss instances. Both timed and unsolicited modes can be on simultaneously via issuing the command again with a different parameter setting. The state values returned are from the state enumeration table provided hereinabove.

In cases of RS232 connected devices with XON/XOFF protocol selected, it is recommended that “X symbol substitution responses” also be selected when configuring the printer's serial port. This requires that the application, upon receiving a FE value byte, discard it and use the next byte to recover the true value, either 11 or 13 or confirming the FE value as real.

Parameters:

| | | |
|---|---|---|
| m = 0 | n immaterial | turn all POS USTATUS modes off |
| m = 1 | n = 0 | turn on unsolicited status reporting |
| | | without power fail option |
| m = 1 | n = 1 | turn on unsolicited status with |
| | | power fail option |
| m = 2 | n = 0 | turn on unsolicited + last command |
| | | status without power fail option |
| m = 2 | n = 1 | turn on unsolicited + last command |
| | | status without power fail option |
| m = 3 | n = # | turn on timed status reporting |
| | seconds if n = | |
| | 0, then off | |
| m = 4 | n = # | turn on timed + last command |
| | seconds if | status reporting |
| | n = 0 then | |
| | off | |

In the timed mode case, a value of n=0 turns off only the timed mode.

The responses sent back to the host have the following formats: For m=1 or 3, 1 D 96 [one of the enumerated state values]. For m=2 or 4 cases, the format is: 1 D 97 [one of the enumerated state values] nL nH c1 c2 f [m s₁ . . . sₙ,], where nL . . . is the same structure as returned from the Printer Extended Command Status command described hereinabove.

If the modes set include the power fail option, the first action of the printer after initialization (and establishing host flow control to allow sending messages back) is to send the following response in the m=1 case:

1D 96 1 [state enumerated value=power cycle occurred]

and in the m=2 case, the power fail response would be:

1D 97 1 0 0 0 0 [no c1 c2 history] 0 [f], returning the initial value (0) of the command counter and indicating no command had yet been executed.

Whenever a state change is to be reported, and more than one exists, then multiple single state reports are sent back to the host.

Since other modifications and changes varied to fit particular operating conditions and environments or designs will be apparent to those skilled in the art, the invention is not considered limited to the examples chosen for purposes of disclosure, and covers changes and modifications which do not constitute departures from the true scope of this invention.

Having thus described the invention, what is desired to be protected by letters patents is presented in the subsequently appended claims.

What is claimed is:

1. A method for linking a status response from a printer to a host with a specific command issued by the host, the steps comprising:
a) generating a quasi-unique ID value and associating said quasi-unique ID value with a command to be issued by a host to a printer operatively connected thereto;
b) issuing said command and said associated quasi-unique ID value to said printer;
c) executing said command at said printer;
d) returning status information from said printer to said host, said status information comprising said quasi-unique ID value.

2. The method for linking a status response from a printer to a host with a specific command issued by the host as recited in claim 1, wherein said quasi-unique ID value comprises an integer generated by said host.

3. The method for linking a status response from a printer to a host with a specific command issued by the host as recited in claim 1, the steps further comprising:
e) storing said command in a buffer within said printer prior to attempting to execute said command step (c).

4. The method for linking a status response from a printer to a host with a specific command issued by the host as recited in claim 3, wherein said buffer comprises at least a current command pointer and a previous command pointer.

5. The method for linking a status response from a printer to a host with a specific command issued by the host as recited in claim 4, wherein said buffer comprises means for storing a last command status byte.

6. The method for linking a status response from a printer to a host with a specific command issued by the host as recited in claim 5, wherein said buffer comprises an input buffer adapted to receive and store a stream of data comprising commands and characters to be printed.

7. The method for linking a status response from a printer to a host with a specific command issued by the host as recited in claim 1, wherein said returning step (d) comprises said host issuing a printer command status (PCS) command to said printer.

8. A method for linking a status response from a printer to a host with a specific command issued by the host, the steps comprising:
a) providing a printer for receiving a stream of data comprising commands and characters to be printed from a host operatively connected to said printer;
b) issuing a plurality of commands from said host to said printer, each of said plurality of commands a quasi-unique ID value;
c) storing said plurality of commands in an input buffer within said printer;
d) parsing said commands in said input buffer; and
e) upon receipt of a PCS command, returning said quasi-unique ID value associated with the command most recently executed by said printer and at least a portion of the status information.

9. A method for restarting a print job in a POS printer, the steps comprising:
a) providing a host computer for supporting a POS printer connected thereto, said host issuing a plurality of commands to said POS printer, each of said commands having a first quasi-unique ID value associated therewith;
b) providing a POS printer connected to said host for receiving and storing said plurality of commands from said host;
c) establishing an identical starting value for both first and second quasi-unique ID values in said host and communicating said second quasi-unique ID starting value to said printer;
d) issuing a plurality of commands at said host and storing said plurality of commands at said printer; and
e) parsing and executing each one of said plurality of commands issued by said host and stored by said printer, as each command is executed, associating said second quasi-unique ID value with the command being executed;
whereby a print job at said POS printer may be restarted dependent upon which of said plurality of commands executed successfully there at.

10. The method for restarting a print job in a POS printer as recited in claim 9, the steps further comprising:
f) incrementing said second quasi-unique ID value upon completion of execution of each of said commands.

11. The method for restarting a print job in a POS printer as recited in claim 10, the steps further comprising:
g) upon request from said host, returning status information from said printer to said host, said status information including said second quasi-unique ID value.

12. The method for restarting a print job in a POS printer as recited in claim 11, the steps further comprising:
h) using said returned status information including said second quasi-unique ID value to determine which of said plurality of commands issued by said host executed properly at said printer.

13. A method for linking a status response from a printer to a host with a specific command issued by the host, the steps comprising:
a) generating a quasi-unique ID value and associating said quasi-unique ID value with a command to be issued by a host to a printer operatively connected thereto;
b) issuing said command and said associated quasi-unique ID value to said printer;
c) monitoring said printer for the occurrence of an abnormal condition which prevents execution of issued commands;
d) generating a unsolicited status response to said host, said unsolicited status response comprising said quasi-unique ID value associated with an issued command upon occurrence of said abnormal condition in said printer.

14. The method for linking a status response from a printer to a host with a specific command issued by the host as recited in claim 13, wherein said abnormal condition comprises at least one from the group: accidental opening of the printer cover during execution of said command, running out of media upon which to print, power failure, and printer input buffer overflow.

15. The method for linking a status response from a printer to a host with a specific command issued by the host as recited in claim 13, wherein said printer comprises means for periodically generating an unsolicited status response to said host.

16. The method for linking a status response from a printer to a host with a specific command issued by the host as recited in claim 15, wherein said period for providing said unsolicited status response to said host is programmable by said host.
